(19) United States
(12) Patent Application Publication
(10) Pub. No.: US 2009/0033219 A1
(43) Pub. Date: Feb. 5, 2009

(54) Electric lamp with an outer bulb and an integral lamp with a method for its production

(75) Inventor: Roland Stark, Wellheim (DE)

Correspondence Address: OSRAM SYLVANIA INC, 100 ENDICOTT STREET, DANVERS, MA, 01923, US

(73) Assignee: OSRAM GESELLSCHAFT MIT BESCHRANKTER HAFTUNG, Munchen (DE)

(21) Appl. No.: 12/153,475

(22) Filed: May 20, 2008

(30) Foreign Application Priority Data
Jul. 30, 2007 (DE) 10 2007 035 596.5

(51) Int. Cl. H01K 1/22; H01J 9/02

(52) U.S. Cl. 313/578; 445/27

(57) ABSTRACT

The invention relates to an electric lamp (1) with a base at one end and with an outer bulb (3), mounted in a base (2), and at least one integral lamp (4), preferably a high-voltage halogen lamp, which is arranged within the outer bulb (3), and at least two power supply wires (6) from the base (2) to the integral lamp (4), the integral lamp (4) being held on the power supply wires (6). At least one of the power supply wires (6) has, in the region of the end (12) on the integral-lamp side, at least one u-shaped bend (11) for accommodating a base (8) of the integral lamp (4).

### TECHNICAL FIELD

The invention relates to an electric lamp with a base at one end and with an outer bulb, mounted in a base, and at least one integral lamp, preferably a high-voltage halogen lamp, which is arranged within the outer bulb, and at least two power supply wires from the base to the integral lamp, the integral lamp being held on the power supply wires.

### PRIOR ART

As a result of their long life and pleasant light quality, halogen incandescent lamps are increasingly preferred to conventional incandescent lamps. In order to make it possible to replace existing incandescent lamps with halogen incandescent lamps as simply as possible and at the same time to maintain the visual appearance of a conventional incandescent lamp for aesthetic or functional reasons, lamps are often used in which the outer contour and therefore in particular the outer bulb and the base correspond to a conventional incandescent lamp, while a halogen incandescent lamp is arranged as an integral lamp within the outer bulb. Such lamps are produced and marketed, for example, by OSRAM GmbH under the designation “HALOLUX® CLASSIC”.

In order to bring the outward appearance and the luminous properties of such a lamp close to those of a conventional incandescent lamp, the incandescent wire of the integral lamp needs to be arranged approximately at the same point as the incandescent wire of a comparable conventional incandescent lamp. For this purpose, the substantially more compact halogen lamp needs to be positioned in the outer bulb by means of a holder.

It is known from EP 0 498 256 to fix the integral lamp directly to power supply wires, which are held in the screw thread of the base of the lamp, and therefore to use these power supply wires as the holder for the integral lamp. However, this is only possible with relatively short power supply wires since otherwise the lamp will be extremely sensitive to vibrations, in particular with the welded joints used to fix the integral lamp to the power supply wires and with the power supply lines of the integral lamp, which are conventionally dimensioned such that they are relatively weak, being at risk of breakage. The welded joints are at great risk of breakage in particular also when the power supply wires are introduced into the lamp base. A further problem with this arrangement consists in the fact that the power supply wires from the base to the integral lamp and the power supply lines passing out of the integral lamp need to be brought into direct contact in order to be able to weld them to one another. This positioning operation is complex and time-intensive.

A technology used in the abovementioned “HALOLUX® CLASSIC” lamps for positioning the integral lamp consists in providing a vitreous plate-like stand, which is fused into the outer bulb. The plate-like stand bears a frame manufactured from metal by means of which the halogen integral lamp is in turn held. Furthermore, power supply wires are fused into the plate-like stand, and the power supply lines of the integral lamp are welded to said power supply wires. This design requires, in order to pass the power supply wires through the vitreous plate-like stand, a three-part design and is generally very complex as a result of the combination of metallic and vitreous components.

DE 10 2005 051 076 has disclosed a holder for the integral lamp, which holder comprises a metallic mounting clip, into which the integral lamp is inserted. The mounting clip is fitted onto the vitreous stand of the outer bulb, which is very involved, however, since the vitreous stand represents a very complex component which comprises, for example, an exhaust tube and fused-in power supply wires. Furthermore, the metallic holder is visually very obvious and considerably disrupts the transparent outward appearance known from a conventional incandescent lamp.

### DESCRIPTION OF THE INVENTION

With respect to the lamp, the invention is therefore based on the object of providing an electric lamp with a base at one end and with an outer bulb, mounted in a base, and at least one integral lamp, preferably a high-voltage halogen lamp, which is arranged within the outer bulb, and at least two power supply wires from the base to the integral lamp, the integral lamp being held on the power supply wires, which lamp can be produced in a robust and simple manner.

The object is achieved according to the invention by virtue of the fact that at least one of the power supply wires has, in the region of the end on the integral-lamp side, at least one u-shaped bend for accommodating a base of the integral lamp. The base can be inserted easily into the u-shaped bend and held there firmly. The welded joint between the power supply line of the integral lamp and the power supply wire is relieved of mechanical forces or force peaks in the same way as the integral lamp itself. U-shaped bends can be produced simply and precisely. The possibility is therefore provided of fixing the integral lamp reliably in a simple manner.

It is particularly advantageous if at least one of the power supply wires has, in the region of the end on the integral-lamp side, at least two u-shaped bends running in opposite directions. Running in opposite directions is regarded as meaning u-shaped bends in which the limbs of the two Us are arranged approximately parallel to one another, while their bays open in approximately opposite directions. A second u-shaped bend represents a particularly simple option of connecting a u-shaped bend, which is open at the top, i.e. away from the base of the lamp, to the power supply wire which is passed out at the bottom, i.e. towards the base of the lamp, since in this case it is possible to dispense with welded joints or other fixings.

It is particularly advantageous if the at least two u-shaped bends running in opposite directions are arranged in the form of an s. Such a sequence of bends can be produced in a particularly simple manner.

In a further embodiment of the invention, the at least two u-shaped bends running in opposite directions are arranged in the form of a loop. This allows for a particularly space-saving arrangement, even in the case of relatively large bending radii of the u-shaped bends, in which arrangement only very low bending torques are transmitted to the power supply wire as a result of the short radial distance between the base of the integral lamp and the power supply wire.

It is furthermore advantageous if at least two power supply wires have, in the region of the end on the integral-lamp side, in each case at least one u-shaped bend for accommodating a base of the integral lamp, and the ends on the integral-lamp side of at least two of the power supply wires are arranged on different sides of the base. As a result, very effective holding of the integral lamp is achieved in which only low bending torques act on the power supply wires.

In a further development of the invention, at least two power supply wires have, in the region of the end on the integral-lamp side, in each case at least one u-shaped bend for accommodating a base of the integral lamp, and the ends on the integral-lamp side of all of the power supply wires are arranged on the same side of the base of the integral lamp. Such an arrangement allows for relatively simple production since in this case the power supply wires can be arranged in a simple manner, for example parallel to the base of the integral lamp, and the integral lamp can then be inserted without any problems.

It is furthermore advantageous if the end on the integral-lamp side of at least one of the power supply wires is bent away from the bay of the u-shaped bend. From a suitably selected inflexion point on, the distance between the limbs of the U is therefore increased towards the opening, which allows for particularly simple insertion of the integral lamp into the u-shaped bend.

It is expedient if the two limbs of the u-shaped bend are arranged approximately parallel to one another. Conventional integral lamps usually have a base with virtually planar-parallel side faces, which in this embodiment are held particularly effectively in the u-shaped bend.

In a further, particularly advantageous embodiment, the two limbs of the u-shaped bend are arranged such that at least sections thereof are inclined towards one another, in particular with the shortest distance between the limbs of the u-shaped bend in the unstressed state being preferably slightly smaller than the thickest point of the base of the integral lamp. Slightly should in this case be understood in particular as meaning a distance at which the expenditure of force when inserting the integral lamp into the u-shaped bend remains sufficiently low to safely avoid damage to the components. It is therefore possible to fixedly clamp the base by means of the spring action of the power supply wire and therefore to increase the holding force.

It is advantageous if at least one of the power supply wires is coiled in the form of a circle and/or helix and/or spiral, preferably in the region of the end remote from the integral lamp. This simplifies the process of fixing the power supply wires in the lamp, in particular in its cylindrical base.

Expediently, the circular and/or helical and/or spiral coil of at least one power supply wire can be fit into a circular groove and/or a thread of the base of the lamp. This allows for simple fixing of the power supply wire in particular also in the axial direction.

It is furthermore advantageous if the end of at least one power supply wire, preferably the power supply wire comprising the circular and/or helical and/or spiral coil, is positioned closer to the integral lamp than that point of the power supply wire which is furthest removed from the integral lamp. As a result, the coil is virtually guided “upwards”. This simplifies the insertion, in particular the process of screwing the power supply wire into the base, since the end of the coil cannot become interlocked when it is inserted into the base and, as a result of this interlocking, prevents movements in the opposite direction which would result in the power supply wire becoming detached.

It is likewise advantageous if the diameter of the coil in the uninstalled state increases towards the side close to the integral lamp. This also simplifies the insertion of the power supply wire into the base of the lamp and allows for a certain clamping effect as a result of the compression of the coil formation during insertion, which makes particularly effective fixing of the power supply wire possible. An additional connection between the base and the power supply wire, for example by means of soldering, adhesive-bonding or welding, is therefore not necessary.

Expediently, at least one limb of the u-shaped bend, preferably the limb remote from the end on the integral-lamp side, is of approximately the same length as the base of the integral lamp. As a result, the base is held particularly effectively and in particular tilting is reliably prevented. The bearing surface area of the power supply wire against the base is maximized, which in particular prevents the occurrence of mechanical stress peaks in the vitreous base.

It is likewise expedient if at least one of the power supply wires is connected to at least one power supply line of the integral lamp by means of welding. As a result, a reliable mechanical and electrical connection is produced and the integral lamp is additionally secured against being laterally displaced in and falling out, in the axial direction, of the u-shaped bend.

By virtue of the fact that the integral lamp has a base with a cross section in the form of a double T, and in each case one u-shaped power supply wire bears against each flange of the base on the inside, the integral lamp is reliably secured against lateral displacement.

Advantageously, the lamp is produced using a method as claimed in claim 17. In this method, the necessary working steps are very few and are simple to carry out, for which reason the method can be implemented in a very efficient and cost-effective manner.

### BRIEF DESCRIPTION OF THE DRAWINGS

The invention will be explained in more detail below with reference to an exemplary embodiment. Identical or functionally identical component parts are identified by the same reference numerals. In the figures:

FIG. 1 shows a lamp according to the invention in a perspective view;

FIG. 2 shows the integral lamp with the holder in a detail view; and

FIG. 3 shows an exploded drawing of a lamp according to the invention.

### PREFERRED EMBODIMENT OF THE INVENTION

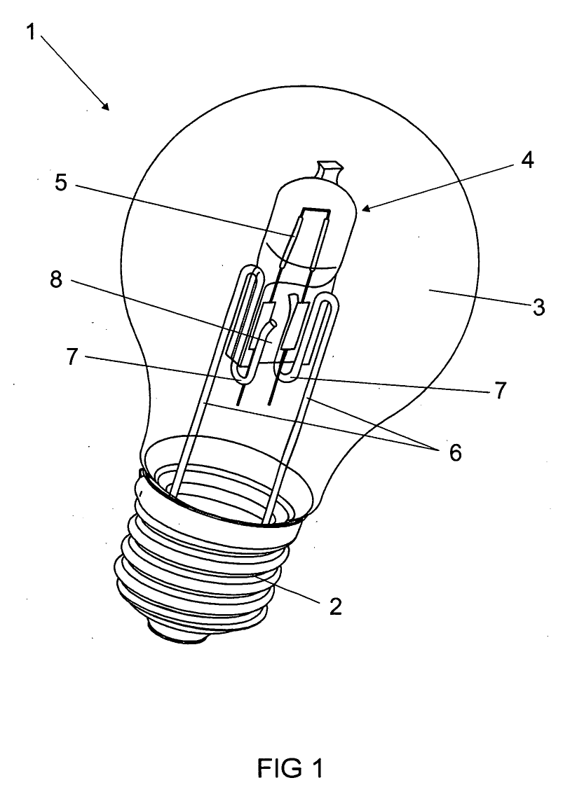

FIG. 1 shows a lamp 1 according to the invention in a perspective illustration. An outer bulb 3 of the type A55 is held in a base 2 of the conventional type E27. An integral lamp 4 is arranged within the outer bulb 3 in such a way that an incandescent wire 5 of the integral lamp 4 is located approximately at the point within the outer bulb 3 at which the incandescent wire is likewise arranged in a conventional incandescent lamp. The integral lamp 4 is configured as a so-called high-voltage halogen lamp using pinching technology and is known as such from the prior art. The integral lamp 4 is held in two power supply wires 6, which are each bent in the form of an s at their end on the integral-lamp side. This results in each case in a u-shaped bend 7, in which the base 8 of the integral lamp 4 is held.

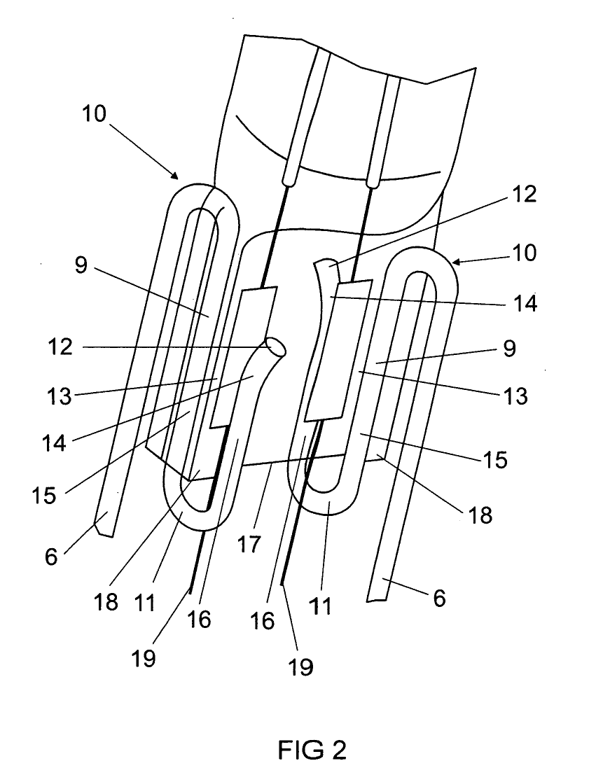

Details of the design can be seen particularly clearly in FIG. 2. The power supply wires 6 are first bent back once coming from the base 2 of the lamp 1, with the result that the wire section 9 points in the direction of the base 2. At a distance which approximately corresponds to the length of the base 8 of the integral lamp 4, the power supply wire 6 is bent back again, with the result that, running in the opposite direction to the first unshaped bend 10, a second unshaped bend 11, which is open towards the integral lamp, is formed. In this case, the two power supply wires 6 are arranged in such a way that their ends 12 are arranged on different sides of the base 8 of the integral lamp 4. As a result, the two power supply wires 6, which bear the integral lamp 4, are arranged diagonally opposite in relation to the base 8 of the integral lamp 4, as a result of which the occurrence of bending torques in the power supply wires 6, as would be the case given an arrangement of the ends 12 of the power supply wires 6 on the same side of the base 8 of the integral lamp 4, is avoided or markedly reduced.

The power supply wires 6 are bent away from the respective bay 13 of the unshaped bend 11 directly at the ends 12, with the result that an inflexion point 14 is formed. As a result, the insertion of the integral lamp 4 into the u-shaped bends 11 during fitting of the lamp 1 is markedly simplified since small dimensional tolerances of the components involved can be compensated for. The two limbs 15, 16 of the u-shaped bends 11 of the power supply wires 6 are inclined slightly towards one another prior to the incorporation of the integral lamp 4, with the result that, when the integral lamp 4 is pushed in, although at first a certain resistance needs to be overcome, the integral lamp 4 then it is sealed very securely in the fitted state.

In the present exemplary embodiment, the limbs 15, 16 of the u-shaped bends 11 are aligned practically parallel after the insertion of the integral lamp 4 and bear over their entire area against the base 8 of the integral lamp 4. However, embodiments are also conceivable in which the limb 16 close to the end only bears against the base 8 of the integral lamp 4 at the inflexion point 14. Embodiments are likewise conceivable in which the limbs 15, 16 of the unshaped bend 11 are arranged approximately parallel even in the unloaded state, i.e. if the integral lamp 4 has not yet been fitted. The clamping effect of the unshaped bend 11 is in this embodiment slightly weaker than in the embodiment shown in the figure, but high mechanical stresses of the base 8 of the integral lamp 4 are avoided for this purpose.

The base 8 of the integral lamp 4 is in the form of a double T with a web 17, which connects two outer flanges 18. The distance between the power supply wires 6 in the transverse direction is selected such that the power supply wires 6 bear against the flanges 18 in the region of unshaped bend 11. As a result, the integral lamp 4 cannot move laterally with respect to the power supply wires 6. In addition, the power supply wires 6 are connected to the power supply lines 19 of the integral lamp 4 by means of welding. As a result, not only is an electrical connection produced which is excellent and is insensitive to corrosion and mechanical stresses, but also the integral lamp 4 is additionally mechanically fixed with respect to the power supply wires 6.

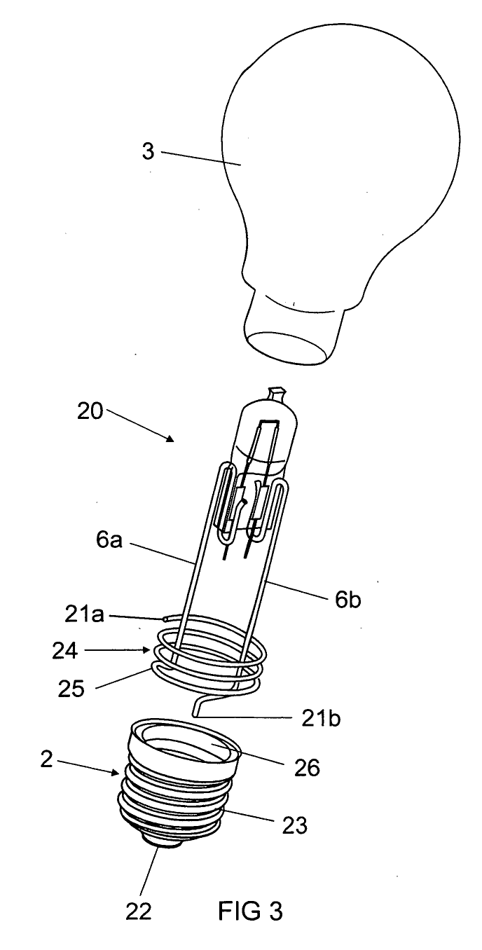

The further design of the lamp 1 and its production are apparent in FIG. 3, which illustrates an exploded drawing of a lamp 1 according to the invention. The unit 20 comprising the integral lamp 4 and the power supply wires 6 is illustrated as being between the outer bulb 3 and the base 2. The integral lamp 4 is held in the power supply wires 6a, 6b, as described above. In the region of the base-side ends 21a, 21b of the power supply wires 6a, 6b, the power supply wire 6b to be connected to a central contact 22 is bent twice at an angle of 90°. The power supply wire 6a which is to be connected to the thread 23 of the base 2 is coiled in helical fashion, the coil 24 and therefore also the end 21a, remote from the integral lamp, of the power supply wire 6a is above, i.e. is closer to the integral lamp 4, than the point 25 which is furthest removed therefrom. This means that, when the coil 24 is screwed into the thread 23, the end 21a of the power supply wire 6a is prevented from being cross-threaded in the thread 23 of the base 2. If the coil 24 is screwed into the base 2, an opposite movement is no longer possible since then the end 21a of the power supply wire 6a becomes skewed in the thread 23 of the base 2 and suppresses further movements in this direction. This effect is intensified further by the diameter of the coil 24 in the uninstalled state increasing from the point 25 which is furthest removed from the integral lamp 4 to the integral lamp 4, which first makes simple screwing-in possible, while the resistance is increased as the penetration depth increases. The clamping effect of the end 21a, remote from the integral lamp, of the power supply wire 6a is therefore also intensified.

When the lamp 1 is fitted, first the power supply wires 6 are bent in advance and the integral lamp 4 is inserted into the u-shaped bends 11 and welded to the power supply wires 6. This unit 20 (illustrated in FIG. 3) comprising the integral lamp 4 and the power supply wires 6 is screwed into the base 2 of the lamp 1, which has already been provided with cement 26. Then, the outer bulb 3 is positioned onto the base 2 and the two are connected to one another by means of the cement 26 which has been applied in advance to the base 2 being heated. Finally, the power supply wire 6a to be connected to the central contact 22 is cut to length and connected to the base 2 by means of soldering.

Yet other embodiments of the invention are of course also conceivable. For example, the power supply wires 6 could have a loop-shaped arrangement instead of an s-shaped arrangement of the u-shaped bends 10, 11, i.e. a view corresponding to the Greek letter φ would result. It is also conceivable for the ends 12 on the integral-lamp side of the power supply wires 6 to be arranged on the same side of the base 8 of the integral lamp 4, which in particular facilitates the alignment of the power supply wires 6 and the base 8 of the integral lamp 4 during fitting. Instead of a welded joint between the power supply lines 19 and the power supply wires 6 of the integral lamp 4, other connection techniques are also conceivable, for example by means of soldering or by means of bending back of the power supply lines 19 of the integral lamp 4.

If the integral lamp 4 has fluting on the base 8, the inflexion point 14 of the power supply wires 6 can be placed in such a way that it engages in a depression of the fluting and thus holds the integral lamp 4 reliably in the axial direction as well.

Instead of the outer bulb 3, which is shown in the exemplary embodiments and is typical of a general-service incandescence lamp, with the designation A55, other bulb shapes, such as the types A60, R63, R80 or G95, for example, are naturally also conceivable, and other base sizes, such as E14 or E40, for example, and other types of base such as a bayonet-type base or plug-type base, for example, are also possible instead of the screw-type base 2 shown of the type E27.

1. An electric lamp (1) with a base at one end and with an outer bulb (3), mounted in a base (2), and at least one integral lamp (4), preferably a high-voltage halogen lamp, which is arranged within the outer bulb (3), and at least two power supply wires (6) from the base (2) to the integral lamp (4), the integral lamp (4) being held on the power supply wires (6), characterized in that at least one of the power supply wires (6) has, in the region of the end (12) on the integral-lamp side, at least one u-shaped bend (11) for accommodating a base (8) of the integral lamp (4).

2. The electric lamp (1) with a base at one end as claimed in claim 1, characterized in that at least one of the power supply wires (6) has, in the region of the end (12) on the integral-lamp side, at least two u-shaped bends (10, 11) running in opposite directions.

3. The electric lamp (1) with a base at one end as claimed in claim 1, characterized in that the at least two u-shaped bends (10, 11) running in opposite directions are arranged in the form of an s.

4. The electric lamp (1) with a base at one end as claimed in claim 2, characterized in that the at least two u-shaped bends (10, 11) running in opposite directions are arranged in the form of a loop.

5. The electric lamp (1) with a base at one end as claimed in claim 1, characterized in that at least two power supply wires (6) have, in the region of the end (12) on the integral-lamp side, in each case at least one u-shaped bend (11) for accommodating a base (8) of the integral lamp (4), and the ends (12) on the integral-lamp side of at least two of the power supply wires (6) are arranged on different sides of the base (8).

6. The electric lamp (1) with a base at one end as claimed in claim 1, characterized in that at least two power supply wires (6) have, in the region of the end (12) on the integral-lamp side, in each case at least one u-shaped bend (11) for accommodating a base (8) of the integral lamp (4), and the ends (12) on the integral-lamp side of all of the power supply wires (6) are arranged on the same side of the base (8) of the integral lamp (4).

7. The electric lamp (1) with a base at one end as claimed in claim 1, characterized in that the end (12) on the integral-lamp side of at least one of the power supply wires (6) is bent away from the bay (13) of the u-shaped bend (11).

8. The electric lamp (1) with a base at one end as claimed in claim 1, characterized in that the two limbs (15, 16) of the u-shaped bend (11) are arranged approximately parallel to one another.

9. The electric lamp (1) with a base at one end as claimed in claim 1, characterized in that the two limbs (15, 16) of the u-shaped bend (11) are arranged such that at least sections thereof are inclined towards one another, in particular with the shortest distance between the limbs (15, 16) of the u-shaped bend (11) in the unstressed state being preferably slightly smaller than the thickest point of the base (8) of the integral lamp (4).

10. The electric lamp (1) with a base at one end as claimed in claim 1, characterized in that at least one of the power supply wires (6a) is coiled in the form of a circle and/or helix and/or spiral, preferably in the region of the end (21a) remote from the integral lamp.

11. The electric lamp (1) with a base at one end as claimed in claim 10, characterized in that the circular and/or helical and/or spiral coil (24) of at least one power supply wire (6a) can be fit into a circular groove and/or a thread (23) of the base (2) of the lamp (1).

12. The electric lamp (1) with a base at one end as claimed in claim 10, characterized in that the end (21a) of at least one power supply wire (6a), preferably the power supply wire (6a) comprising the circular and/or helical and/or spiral coil (24), is positioned closer to the integral lamp (4) than that point (25) of the power supply wire (6a) which is furthest removed from the integral lamp (4).

13. The electric lamp (1) with a base at one end as claimed in claim 10, characterized in that the diameter of the coil (24) in the uninstalled state increases towards the side close to the integral lamp.

14. The electric lamp (1) with a base at one end as claimed in claim 1, characterized in that at least one limb (15, 16) of the u-shaped bend (11), preferably the limb (15) remote from the end (12) on the integral-lamp side, is of approximately the same length as the base (8) of the integral lamp (4).

15. The electric lamp (1) with a base at one end as claimed in claim 1, characterized in that at least one power supply wire (6) is connected to at least one power supply line (19) of the integral lamp (4) by means of welding.

16. The electric lamp (1) with a base at one end as claimed in claim 1, characterized in that the integral lamp (4) has a base (8) with a cross section in the form of a double T, and in each case one u-shaped power supply wire (6) bears against each flange (18) of the base (8) on the inside.

17. A method for producing an electric lamp (1) with a base at one end as claimed in claim 1, characterized by the following steps:
a) the power supply wires (6) are bent in advance;
b) the integral lamp (4) is inserted into the unshaped bend (11) of the power supply wires (6) and connected, preferably welded, to the power supply wires (6);
c) the unit (20) comprising the integral lamp (4) and the power supply wires (6) is screwed into the base (2) of the lamp (1);
e) the outer bulb (3) is applied to the base (2) and is preferably connected using cement (26) applied to the base (2);
f) the power supply wires (6b) are cut to length and connected to the central contact (22) of the base (2), preferably by means of soldering.
